(19) United States
(12) Patent Application Publication
(10) Pub. No.: US 2005/0129047 A1
(43) Pub. Date: Jun. 16, 2005

(54) SWITCH CAPABLE OF CONTROLLING DATA PACKET TRANSMISSION AND RELATED METHOD

(76) Inventors: Hau-Chun Ku, Taipei Hsien (TW); Weipin Chen, Taipei Hsien (TW); Ruth Lin, Taipei Hsien (TW); ChaoCheng Cheng, Taipei Hsien (TW)

Correspondence Address: NORTH AMERICA INTERNATIONAL PATENT OFFICE (NAIPC), P.O. BOX 506, MERRIFIELD, VA, 22116, US

(21) Appl. No.: 10/904,870

(22) Filed: Dec. 1, 2004

Related U.S. Application Data
(60) Provisional application No. 60/481,778, filed on Dec. 12, 2003.

(51) Int. Cl. H04L 12/66; H04L 12/28

(52) U.S. Cl. 370/428; 370/392; 370/417

(57) ABSTRACT

A switch capable of controlling data packet transmission includes at least one input port for receiving a data packet, at least one output port for outputting the data packet, a queue buffer for holding the received data packet, and a analyzing-processing unit for determining how to transmit the received data packet based on a transmission requirement of the received data packet.

### CROSS REFERENCE TO RELATED APPLICATIONS

This application claims the benefit of U.S. Provisional Application No. 60/481,778, filed Dec. 12, 2003, and included herein by reference.

### BACKGROUND OF INVENTION

1. Field of the Invention

The present invention relates to a switch capable of controlling data packet transmission, more particularly, to a switch capable of controlling data packet transmission according to a high-speed transmission requirement and a high-accuracy transmission requirement.

2. Description of the Prior Art

As applications of networks flourish, personal users and companies rely more and more on networks today, especially Ethernet. The International Organization for Standardization (ISO) provides an open system interconnect mode (OSI) which can be accessed by the public. Standard network transmission uses a common mode in which there are seven levels of communication mode. The seven levels allow correspondence such as transmission, receiving and interruption, between two systems to be better managed. Since they are well-known to those skilled in the art, the functions and usage of OSI will not be further mentioned here.

Before the transmission of data, the data is first divided into packets, and these packets are tagged with header information used for controlling the packet transmission. Please refer to FIG. 1, FIG. 1 illustrates a diagram of a data link layer of a packet 10. The data link layer belongs to level 2 of the OSI, which is a level that a switch normally acts on. The data link layer of the packet 10 comprises a preamble field, a destination field, a source field, a type field, data field, and a frame check sequence field. Among these the preamble field provides information such as marking the beginning of the data packet, identifying synchronized message and decoding, etc. The destination field stores an end address of the data packet, and the source field stores a transmission of the address; both the destination field and the source field also store a medium access control (MAC) address. The type field stores a protocol (for example, IP protocol), the data field stores data content of the packet, and lastly the frame check sequence field allocates a check bit for a cyclic redundancy check (CRC).

Please refer to FIG. 2. FIG. 2 illustrates a diagram of local network 20 architecture. Local network 20 comprises a hub 24 or a switch 26, and one or more clients 28 coupled to the hub 24 or the switch 26. In the local network 20, which can range from tens to over hundreds of clients 28 connecting to the local network 20 at the same time, in order to ensure the speed of the local network 20, the hub 24 and the switch 26 increase intensities of signals and functions of network management. However, the hub 24 operates at a physical level of the OSI and is unable to analyze the MAC address field of the data link layer packet header. In other words, when the hub 24 receives a data packet, the data packet is transmitted to other ports. All the clients 28 that are connected to the same hub need to use up part of the bandwidth to process the received data packet, thus collisions of packets cannot be eliminated. If the number of clients in the network increases, efficiency will drop due to sharing of the same bandwidth.

The switch can solve these problems. As the switch operates at the level 2 data link layer of the OSI, when the data is divided into packets, the switch using point-to-point mode allocates the packet to the destination according to the MAC address (which is the destination field of FIG. 1). The switch at the same time can have many parallel transmissions, in this way, a chance of collision is lowered and also the bandwidth is put to full use, and hence, the efficiency of the whole network is increased.

Other than the hub and the switch, there is another apparatus known as a router. The main function of the router is packet transmission, and the router first needs to read the header of the packet to complete the transmission according to a method of processing each of the data within the header. At the same time, the router is capable of selecting a suitable route for the packet. The router determines a best route through setting up a routing table, and a related address is created for the router to refer to in order to seek the best suitable route. There are two methods of doing so: routing information protocol (RIP) and open shortest path first (OSPF). The principle behind RIP is that a request packet is sent out to an adjacent router, the receiving router sends back a routing table, and thus the request packet router can calculate the number of nodes in reaching every destination and record the nearest route in its own routing table. The main difference between OSPF and RIP is that OSPF is not an exchange between two routers but a broadcast over the entire network. Another difference is that the router uses a distance matrix instead of nodes in connecting situations to update distance parameters, and then uses a dynamic programming algorithm to calculate the shortest route. The next node and the total calculation of the distance parameter are filled into the routing table. No matter which method used, each router will automatically detect the information and create a communicating routing table to display the network situation of each channel, whether congested or interrupted, to create the best route for the data packet for ensuring transmission flow.

Although the router is capable of seeking the shortest route, it only functions at the third network layer of the OSI. A normal IP protocol belongs to the network layer protocol, and only an IP address above the network layer serves a purpose, addresses below the network layer are verified by the MAC address. In processing the packets, the router does not verify transmission addresses directly through the MAC address like the switch does, but rather through an address resolution protocol (ARP) that changes the IP protocol into a protocol of the MAC address, in order to know where each layer under the network layer sends the data to, or by using reverse address resolution protocol (RARP) in reverting the ARP to seek the IP address from the MAC address. In this way, cost and complexity of the router is high, and under commercial considerations the router cannot replace the switch or the hub.

Most data transmission in a network splits the data into many packets at the source and transmits these packets to the destination end where the packets are assembled again. There are different types of data transmission schemes. As for online movies or online broadcasting, user demand is for smooth sound and visual transmission, through processing the sound and video will effectively reduce errors caused by data packet transmission, hence the network transmission puts emphasis on smooth high-speed transmission. As for electronic mail or program file transmission, a completed transmission is required in order to open the mail or the file, if part of the packet is not transmitted properly, the content will be corrupted, hence the network transmission puts emphasis on the accuracy of content transmission.

FIG. 3 illustrates a basic structure layout of a switch 30a that comprises at least an input port 32, at least an output port 34a, a processing unit 36a, and a queue buffer 38a. The input port 32a and the output port 34a each couples to one of end 40a of the network, such as a client, a router, a hub or a switch; the queue buffer 38a for temporarily storing the packet or part of the packet outputted from the output port 34a and received in the input port 32a; and the processing unit 36a that controls the way of processing the packet in the queue buffer 38a. By using a store-and-forward mode, according to a standard setting of the processing unit 36a, the completed packet is received and checked for completeness and accuracy before transmitting the packet; or by using a cut-through mode, in receiving part of the packet, judging the destination of the packet, and receiving and sending the packet at the same time. It is obvious that those skilled in the art will recognize that the switch is unable to differentiate whether the data packet transmission requires an accurate transmission or time efficient transmission, and hence cannot find the best possible transmission according to the transmission property of the received data packet.

Furthermore, those skilled in the art will know that the router has a function that seeks the shortest route. However this function basically determines the best route in terms of the transmission speed of every route, and not according to the property of the data packet transmission. Besides, for the router, the data packet usually needs to be resolved to the third layer and therefore the processing time and cost is increased.

### SUMMARY OF INVENTION

The present invention relates to a switch and related method capable of using a queue buffer to process the output mode of the data packet according to a requirement in the property of the data packet transmission.

One preferred embodiment of the claimed invention comprises a switch for controlling the data packet transmission in the network wherein the switch further comprises an input port for receiving data packet; an output port for outputting data packet; a queue buffer for temporarily storing the received data packet; and an analyzing-processing unit for using the queue buffer to process the output mode of the data packet according to the property of the data packet transmission.

One preferred embodiment of the claimed invention further comprises a method for processing data packet transmission in a network by a switch wherein a data packet is received; the output mode of the data packet is selected according to the property of the data packet transmission; and the data packet is transmitted according to the selected mode.

In determining the property of the data packet transmission in the claimed invention, which is basically differentiating whether the data packet requires a high-speed transmission requirement or a high-accuracy transmission requirement. The store-and-forward mode ensures the accuracy of the data packet received by the switch, and the cut-through mode ensures a faster speed of data packet received by the switch. Therefore when the high-speed transmission requirement is needed, the claimed invention uses the cut-through mode, and when the high-accuracy transmission requirement is needed, the claimed invention then uses the store-and-forward mode.

Furthermore, the method of the claimed invention is capable of determining whether content of the data packet is a multimedia file or a program file. The method is also capable of determining whether transmission protocol used is a user datagram protocol (UDP), transmission control protocol (TCP), or another method. In the high-speed transmission requirement, the preamble of the data packet and the MAC address field are first received and stored in the queue buffer and the data packet is sent out immediately; for the high-accuracy transmission requirement, all the addresses of the data packet stored in the queue buffer are first checked for accuracy before the data packet is sent out.

According to another advantage of the claimed invention, the switch is capable of determining the property of the data packet transmission through analyzing content of a particular byte of the data packet to change the output mode of the queue buffer. Also, unlike the router, the claimed invention does not need to change the header of the data packet, hence simplifying operation and reducing cost.

These and other contents of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a format of a data link layer of a packet according to the prior art.

FIG. 2 illustrates a diagram of a conventional local network architecture.

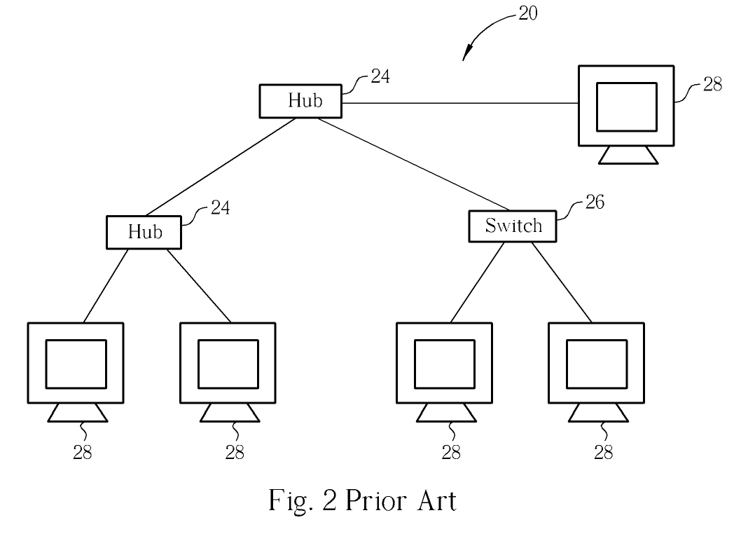

FIG. 3 illustrates a prior art functional block diagram of a switch and an end that transmits and receives data packets.

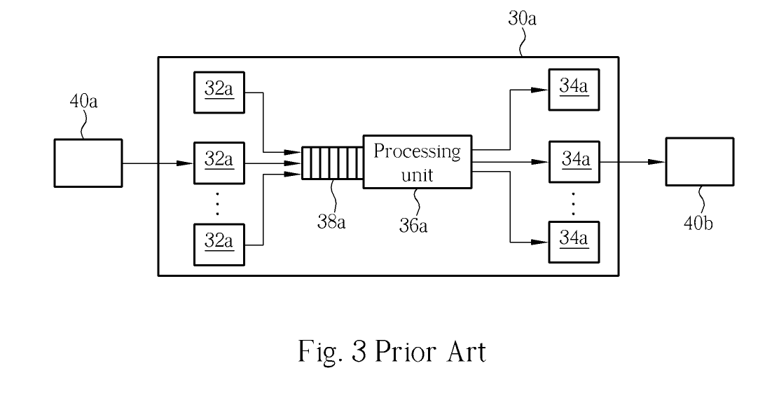

FIG. 4 illustrates a functional block diagram of a switch, an end that transmits and receives data packets, and a receiving end according to the present invention.

FIG. 5 is a diagram of an IP packet format.

FIG. 6 is a diagram of a TCP packet format.

FIG. 7 is a diagram of a UDP packet format.

FIG. 8 is a flowchart of a method according to the present invention.

### DETAILED DESCRIPTION

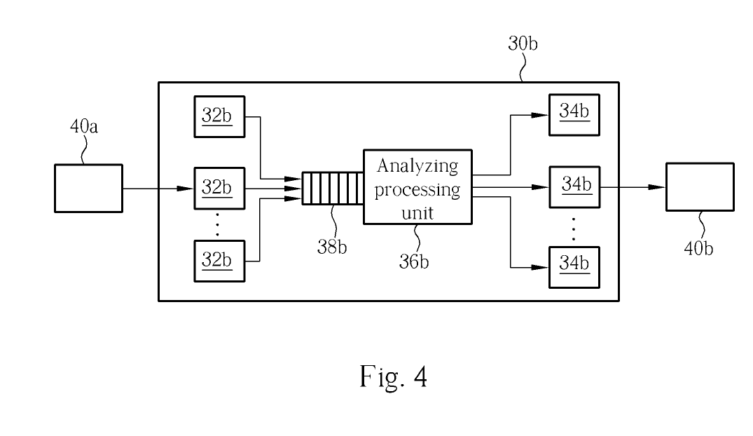

Please refer to FIG. 4. FIG. 4 illustrates a diagram of a switch 30b, a source end 40a, and destination end 40b. Both the source end 40a and destination end 40b can be a client, a router, a hub, or another switch. The switch comprises one or more input port 32b for receiving a data packet from the source end 40a, one or more output ports 34b for outputting a data packet to the destination end 40b, one queue buffer 38b for temporarily storing a data packets received by the input port 32, and one analyzing processing unit 36b for selecting the mode of processing the data packet by the queue buffer 38b and the output port 34b according to the transmission property at least part of the data packet stored in the queue buffer 38b.

The present invention determines whether the transmission property of the data packet is a high-speed transmission requirement or a high-accuracy transmission requirement. In a more detailed explanation, based on the content of the data packet, the invention can determine whether a high-speed transmission requirement is needed, as in the case of a multimedia file, or a high-accuracy transmission requirement is needed, as in the case of a program file. In addition, the present invention can determine whether the data packet has a fast-transmission format or an accurate-transmission format through determining the format of the packet; or by reading the content of the data packet to determine the associated transmission property of the data packet.

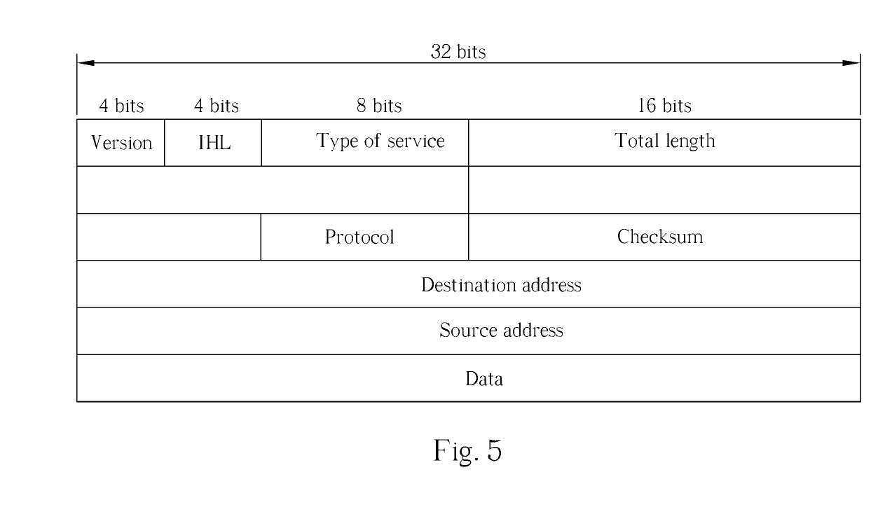

In order to explain the operation of the present invention, please refer to FIG. 5. FIG. 5 illustrates the format of an IP packet. A version field in the IP packet stores the version of the protocol in the data packet. A network header length (IHL) field sets the length of the IP header of the IP packet where the value is 5 to 15. In FIG. 5, the value of the IHL stored is 5. A total length field stores the full length of the IP packet which includes the length of the IP header and length of the data. A protocol field stores type of network protocol used. For example, if the value of the protocol field is 6, it represents TCP, and if the value of the protocol field is 17, it represents a UDP. A checksum field ensures the completeness of the IP header. A source address stores the address of the sending client and a destination address stores the address of the receiving client. The source address and the destination address are actually IP addresses. A data field stores data.

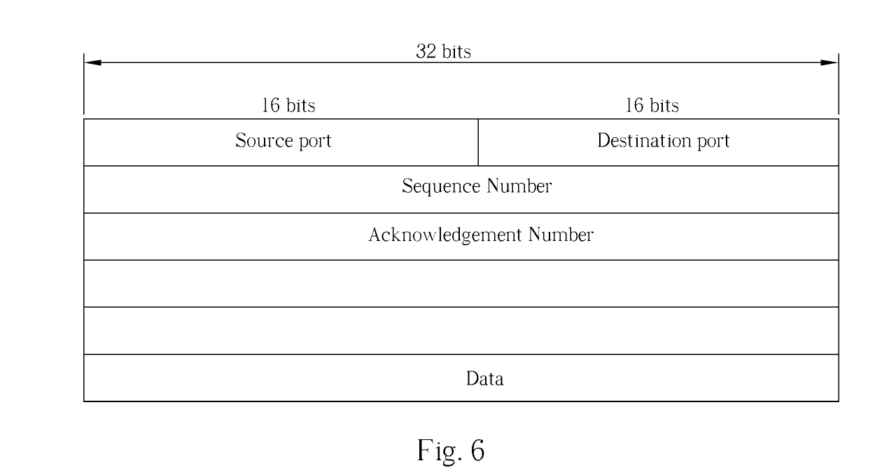

Because each IP packet transmission has a different arrival time, the sequence of arriving packets does not represent the sent sequence, and this may cause errors in transmission. To ensure that a packet arrives correctly, in general, TCP is used to strengthen reliability of transmission. Therefore the data field of the IP packet stores a TCP packet. Please refer to FIG. 6. FIG. 6 illustrates the format of a TCP packet. A source port field can be used to define a source client route and a service address, which when combined with the IP address of the source client forms a send-out point. A destination port field can be used to define a destination client route and a service address, which when combined with the IP address of the destination client forms a send-out point. For example, a port number of 25 corresponds to an SMTP service, a port number of 21 corresponds to a file transfer protocol (FTP) service, and a port number of 23 corresponds to a TELNET service. A sequence number field stores a sequence number of first byte sent out by the source client. An acknowledgement number field stores data of when the source client notifies the destination client which sequence number is to be sent. Generally, TCP is used to ensure the reliability of data transmission, which also means by using the TCP transmission, the packet can arrive at the destination in sequence. The TCP packet will not be described further, since it is well known.

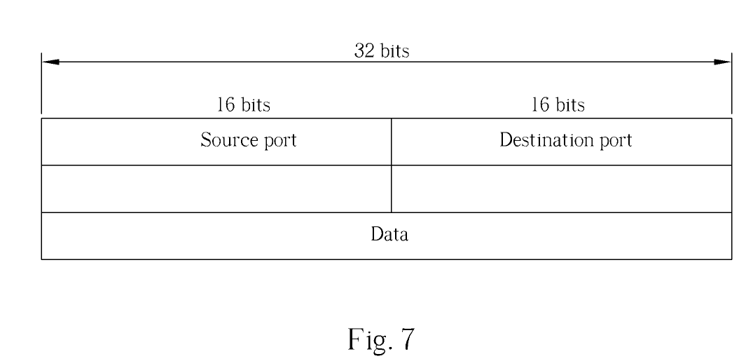

Please refer to FIG. 7. FIG. 7 illustrates the format of a UDP packet. A source port field can be used to define a source client route and a service address. A destination port field can be used to define a destination client route and a service address. UDP does not guarantee that a data packet sent out with a specific sequence will arrive at the destination or will arrive in the same sequence. However, in a local network, the UDP transmission almost reaches with an arrival rate of 100%, and the velocity of arrival can actually be faster than the velocity of processing by the receiving end. As UDP uses a short packet and simple parameters, it is unlike TCP which needs additional fields to control the reliability of transmission, and then the load in the network is lighter in comparison to TCP. Therefore the UDP protocol is mostly used in multi-media file transmission. Further description of UDP is omitted since it is well known.

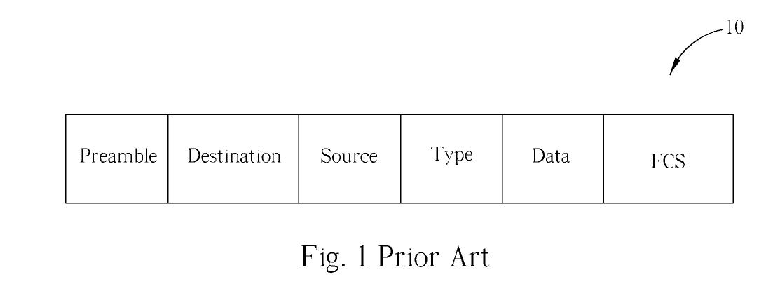

Please be aware that the IP packet of the network layer in FIG. 5 is stored in the data link layer packet 10 of FIG. 1. The TCP packet of FIG. 6 or the UDP packet of FIG. 7 is stored within the IP packet.

In one embodiment of the present invention, the particular address field (or a particular byte) of every data packet already has its own fixed definition. Therefore when the input port 32b of switch 30 receives a data packet, the packet is then temporarily stored into the queue buffer 38b. The analyzing-processing unit 36b takes down the MAC address field of the data link layer to determine the MAC address of the data packet sent out by the source end 40a, and the predicted MAC address of the receiving data packet of the destination end 40b. In addition, under the circumstance where the IP header of the network layer is not moved by the switch 30b of the present invention, the data of the particular field of the IP header is read to determine priority of the receiving data packet. As the particular address field of every data packet has its own fixed definition, the analyzing-processing unit 36b can remove the header of data link layer without removing the IP header and determine the property of the data packet. For example, the analyzing-processing unit 36b only needs to take down the header of data link layer for reading the number in the version field from a 1st bit to a 4th bit to determine the version of the receiving IP packet used, from a 5th bit to an 8th bit to determine the length of the IP packet used, and from a 73rd bit to an 80th bit to determine type of protocol used for transmission, and so forth. The same method can be used to determine the source address and the destination address afterwards. Eventually, the header of the TCP/UDP packet comes after the IP header. Referring to FIG. 5, the value of the IHL is 5, and therefore the number in the version field from a 161st bit to a 176th bit belongs to the TCP/UDP packet of the source port and the number from a 177th bit to a 192nd bit belongs to the TCP/UDP packet of the destination port. The analyzing-processing unit 36b can also quickly interpret a port number that the packet uses. For example, if the port number is 25, the data packet will be used by the SMTP service, if the port number is 21, the data packet will be used by the FTP service. Lastly, the analyzing-processing unit 36b is able to decide which mode to use for the data packet transmission according to data such as protocol of transmission.

Those skilled in switch operation will know that data is divided into packets according to the step of transmitting packets by the MAC address. In addition, the switch uses hardware/firmware to divide data and read the content of the data. The present invention of analyzing packets can be realized through the protocol of transmission, corresponding port number and other related steps, those skilled in the art will know that this can be accomplished by hardware/firmware of the switch. For example, a circuit or program in system memory of the analyzing-processing unit 36a includes a setting/parameter/code relating to the present invention to realize the embodiment, and the analyzing-processing unit, therefore will not be further mentioned. Please be aware that the embodiment of the present invention allows the switch to change accordingly to different packets, sometimes by executing the store-and-forward mode and sometimes by the cut-through mode. Therefore, corresponding hardware has to be capable of performing both needs and the size of the queue buffer 38b has to be in accordance to the needs of the store-and-forward mode.

In one embodiment of the present invention wherein there are two modes of processing packets by using the queue buffer 38b and output port 40b, the first mode is a store-and-forward mode, wherein when a packet is transmitted from the input port 32b to the switch 30b the packet is first temporarily stored in the queue buffer 38b until all fields of the data packet are stored in the queue buffer 38b, and only after the analyzing-processing unit 36b checks for the completeness of the data packet the data packet could be transmitted through at least one output port 34b. Another mode is the cut-through mode, wherein when the packet is transmitted from the input port 32b to the switch 30b, the data packet's preamble and destination MAC address fields are analyzed by making use of the destination of MAC address field to determine receiving end of MAC address, while at the same time the packet is sent from the input port 32b through to the output port 34b. The difference between the two modes is speed and accuracy of transmission. The former mode needs to wait until all fields of the data are received, and if necessary, check for accuracy before transmitting the packet away. In comparison, the latter mode only needs to transmit the packet after receiving the destination of the MAC address field. The processing time is short but errors are not checked, therefore an erroneous packet may be transmitted.

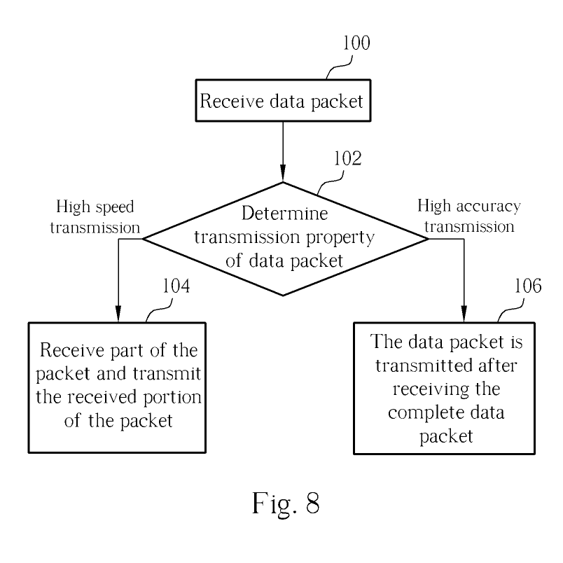

Please refer to FIG. 8, FIG. 8 illustrates a functional flowchart of a method according to the present invention. The steps are as follows:

Step 100: Receiving s data packet;

Step 102: Determining the transmission property of the data packet. If the transmission property of the data packet is high-speed transmission, then proceed to step 104; if the transmission property of the data packet is high-accuracy transmission, then proceed to step 106;

Step 104: After receiving the data packet in the preamble and the destination of the MAC address field, simultaneously receive part of the packet and transmit the received portion of the packet;

Step 106: The data packet is transmitted after receiving the complete data packet.

In one example, the end 40b uses UDP to transmit a multi-media file to another end 40b. In the present invention, after the switch 30b with the input port 32b receives a data packet (step 100), the analyzing-processing unit 32b determines the property of the data packet transmission (such as determining the type of protocol the data packet in step 102). When the switch 30b receives a data packet from the input port 32b, the analyzing-processing unit 36b can determine the end 40b where the packet needs to be transmitted through the MAC address field. The analyzing-processing unit 36b can determine whether the data packet uses UDP by a number 17 in the version field from the 73rd bit to 80th bit. Hence, the data packet transmitted uses the cut-through mode. After receiving and analyzing the data packet in the preamble and the destination of the MAC address field, and combining the preamble, the destination and other data packet are transmitted directly through the output port 34b.

In another example, an end 40b uses TCP to transmit an electronic mail to another end 40b. The switch 30b with the input port 32b receives the data packet of the electronic mail (step 100), and the analyzing-processing unit 36b determines the end 40b where the packet needs to be transmitted through the MAC address field. According to a value of 6 in the version field from the 73rd bit to the 80th bit, that the data packet uses a TCP protocol is determined. Hence, the switch 30b uses the store-and-forward mode on the data packet received, which is also after the field of the data packet is fully stored in the queue buffer 38b, and after the analyzing-processing unit 36b checks for accuracy of the preamble field, destination field, source field, type field, and FCS field. The data packet is then transmitted through the output port 34b. There will almost be no packet error, but the latency will be increased.

In comparison to the prior art, the switch of the present invention is capable of using the setting of a particular byte in a current network layer packet to analyze a data link layer of the data packet transmitted by the switch. Other than splitting and analyzing the label of the data link layer by reading information of a fixed field of the label of the network layer packet, the switch is capable of differentiating the protocol used by the network layer packet and the port number used etc., to decide whether the network layer packet places emphasis on time efficiency or accuracy. If emphasis is placed on time efficiency, the cut-through mode is used to transmit the data packet to reduce latency. In contrast, if emphasis is placed on accuracy, the store-and-forward mode is used to ensure that the data packet transmission is accurate. Through such control mechanism, the switch of the local network of the present invention can provide the best network transmission management.

Those skilled in the art will readily observe that numerous modifications and alterations of the device may be made while retaining the teachings of the invention. Accordingly, the above disclosure should be construed as limited only by the metes and bounds of the appended claims.

1. A switch capable of controlling data packet transmission in a network, the switch comprising:
an input port for receiving a data packet;
a queue buffer coupled with said input port, said queue buffer being used to temporarily store the data packet received from the input port;
an output port coupled with said queue buffer, said output buffer being used to output the data packet; and
an analyzing-processing unit coupled with said queue buffer and said output port, said analyzing-processing unit being used to select a mode of the queue buffer and the output port for processing the data packet according to at least a transmission property of the data packet.

2. The switch of claim 1 wherein said transmission property is chosen from the group consisting of the following: high-speed transmission requirement and high-accuracy transmission requirement.

3. The switch of claim 1 wherein the data packet complies with an Internet protocol.

4. The switch of claim 1 wherein if the data packet contains a multimedia file, the analyzing-processing unit determines the transmission property of the data packet to be a high-speed transmission requirement.

5. The switch of claim 1 wherein if the data packet contains a program file, the analyzing-processing unit determines the transmission property of the data packet to be a high-accuracy transmission requirement.

6. The switch of claim 1 wherein if a transmission protocol of the data packet is a UDP, the analyzing-processing unit determines the transmission property of the data packet to be a high-speed transmission requirement.

7. The switch of claim 1 wherein if a transmission protocol of the data packet is a TCP, the analyzing-processing unit determines the transmission property of the data packet to be a high-accuracy transmission requirement.

8. The switch of claim 1 wherein a transmission protocol of the data packet is stored in a protocol identifier field of the data packet.

9. The switch of claim 2 while the analyzing-processing unit determines the transmission property of the data packet to be a high-speed transmission requirement, and after the queue buffer stores a preamble field and a MAC address field, the analyzing-processing unit and the queue buffer receive part of the data packet through the input port and output part of a received data packet previously stored in the queue buffer at the output port.

10. The switch of claim 2 while the analyzing-processing unit determines the transmission property of the data packet to be a high-accuracy transmission requirement, the queue buffer and the analyzing-processing unit first store a complete data packet in the queue buffer to check its validity and then send out the data packet.

11. A method of a switch for processing data packet transmission in a network, the method comprising:
receiving a data packet;
selecting a mode of processing the data packet according to at least a transmission property of the data packet; and
processing the data packet according to the selection of mode.

12. The method of claim 11 wherein transmission property is chosen from the group consisting of the following: high-speed transmission requirement and high-accuracy transmission requirement.

13. The method of claim 11 wherein the data packet complies with an Internet protocol.

14. The method of claim 11 wherein if the data packet contains a multimedia file, the transmission property of the data packet is decided to be a high-speed transmission requirement.

15. The method of claim 11 wherein if the data packet contains a program file, the transmission property of the data packet is a high-accuracy transmission requirement.

16. The method of claim 11 wherein if a transmission protocol of the data packet is a User Datagram Protocol (UDP), the transmission property of the data packet is decided to be a high-speed transmission requirement.

17. The method of claim 11 wherein if a transmission protocol of the data packet is a Transmission Control Protocol (TCP), the transmission property of the data packet is decided to be a high-accuracy transmission requirement.

18. The method of claim 11 wherein a transmission protocol of the data packet is stored in a protocol identifier field of the data packet.

19. The method of claim 11 while the transmission property of the data packet is a high-speed transmission requirement, after storing a preamble field and a Medium Access Control (MAC) address field, part of the data packet is received through an input port and a part of the received data packet that was previously stored is output through an output port.

20. The method of claim 11 while the transmission property of the data packet is a high-accuracy transmission requirement, complete data packet is first stored to check for validity before the data packet is sent out.
